(19) United States
(12) Patent Application Publication
(10) Pub. No.: US 2020/0212521 A1
(43) Pub. Date: Jul. 2, 2020

(54) TEMPERATURE CONTROL DEVICE FOR A BATTERY SYSTEM AND BATTERY SYSTEM

(71) Applicant: LION Smart GmbH, Garching (DE)

(72) Inventors: Christian BEHLEN, München (DE); Mark ALLMENDINGER-HAGENMAIER, Groebenzell (DE); Tobias MAYER, München (DE)

(73) Assignee: LION Smart GmbH, Garching (DE)

(21) Appl. No.: 16/633,980

(22) PCT Filed: Jul. 26, 2018
(86) PCT No.: PCT/EP2018/070341

§ 371 Date: Jan. 24, 2020

(30) Foreign Application Priority Data
Jul. 27, 2017 (DE) 10 2017 116 984.9

(51) Int. Cl. H01M 10/63; H01M 10/6568; H01M 10/617; H01M 10/625; H01M 10/6556; H01M 2/10; H01M 10/0525

(52) U.S. Cl. CPC H01M 10/63; H01M 10/6568; H01M 10/617; H01M 2220/20; H01M 10/6556; H01M 2/1077; H01M 10/0525; H01M 10/625

(57) ABSTRACT

A temperature control device for temperature control of a battery system has at least one battery element. The temperature control device has a temperature control line for conducting a temperature control fluid in a flow direction. The temperature control line includes a flow section, a return section, a first temperature control branch and a second temperature control branch. The first temperature control branch includes a first inflow opening fluidly communicating connected to the flow section, and a first outflow opening fluidly communicating connected to said return section. The second temperature control branch includes a second inflow opening fluidly communicating connected to said flow section, and a second outflow opening, which is fluid-communicating connected to the return section. The first temperature control branch and the second temperature control branch are connected in fluid mechanical parallel to one another and each have a temperature control section for temperature control a battery element of the battery system.

### CROSS-REFERENCE TO RELATED APPLICATION

This application is a national stage application, filed under 35 U.S.C. § 371, of International Patent Application No. PCT/EP2018/070341, filed on Jul. 26, 2018, which claims priority to German Patent Application 102017116984.9, filed on Jul. 27, 2017, the entire contents of each of which is incorporated by reference herein in its entirety.

### BACKGROUND OF THE DISCLOSURE

### 1. Field of the Disclosure

The invention relates to a temperature control device for temperature control a battery system with at least one battery element, the temperature control device comprising a temperature control line for conducting a temperature control fluid in a flow direction, wherein the temperature control line comprises a flow section, a return section, a first temperature control branch and a second temperature control branch, the first temperature control branch comprising a first inflow opening fluidly communicating connected to the flow section, and a first outflow opening fluid-communicating connected to said return section, said second temperature control branch comprising a second inflow opening fluid-communicating connected to said flow section and a second outflow opening fluid-communicating connected to said return section, wherein further said first temperature control branch and said second temperature control branch are fluid-mechanically connected in parallel to each other and each comprises a temperature control section for temperature control a battery element of said battery system. Furthermore, the invention concerns a battery system comprising at least one battery element and a temperature control device.

### 2. Description of Related Art

Electric energy storage devices are widely used in modern technology, for example in electric vehicles. Possible forms of such energy storage are, for example, lithium-ion batteries. In order to increase the performance of such batteries, it is known, for example, that several individual battery elements, especially battery cells, are electrically connected in parallel at one battery level. To achieve a further increase, two or more of these battery levels can be connected in series to form a battery stack. In particular, the individual battery levels can be arranged on top of each other and electrically connected.

During an operation of a battery system, heat generation is usually not negligible. However, a too low temperature of the battery system is also a hindrance to effective operation of a battery system. Temperature control of the battery system, especially of the individual battery elements of the battery system, is therefore usually unavoidable. Thermal damage to the battery elements or the entire battery system can be avoided by the presence of temperature control devices. Well-known temperature control devices often have a temperature control line in which a temperature control fluid flows in one flow direction. By means of a thermally conductive connection between the temperature control line, for example a temperature control section of the temperature control line, and the individual battery elements of a battery system, thermal energy, in other words waste heat from the battery elements, can be absorbed by the temperature control fluid and transported away from the battery elements, or can be transported by the temperature control fluid to the battery subsystems and transferred to them.

Known temperature control devices for the temperature control of battery systems with several battery elements may provide, in accordance with the state of the art, that the temperature control line extends in a curving manner through at least one section of the battery system or even the entire battery system. In this way, many, preferably all, areas of the battery system can be reached by the temperature control line, whereby a temperature control capability of the temperature control device can be provided distributed over the entire battery system. A disadvantage of such a curved-shaped arrangement of the temperature control line, however, is that the temperature of the temperature control fluid increases or decreases continuously due to the absorption or release of heat energy from or to the battery elements in the flow direction of the temperature control fluid, so that the temperature control performance of such a temperature control device decreases more and more along the temperature control line.

In a further embodiment according to the state-of-the-art temperature control devices, it is alternatively known that the temperature control line is divided into several temperature control branches. The temperature control branches branch off from a flow section of the temperature control line and flow back into a return section, it further being known according to the state of the art that the flow directions of the temperature control fluid in the flow section and in the return section are substantially opposite, so that the individual flow paths of the temperature control fluid through the flow section, the respective temperature control branch and the return section result at least schematically in a substantially U-shaped shape. The temperature control branches of the individual flow paths branch off from a common flow section and a common return section so that they are stacked and merge into one another. In this way it can be provided that the individual temperature control branches can be operated with a temperature control fluid with at least essentially the same temperatures, so that the temperature control performance can be increased in comparison to a curved-shaped arranged individual temperature control line. However, this nesting of the U-shaped flow paths results in significantly different lengths for the individual temperature control branches, so that a pressure and/or a volume flow of temperature control fluid in the individual temperature control branches can automatically differ significantly. Even in this embodiment according to the state of the art of a temperature control device, there can be significant differences in temperature performance in the individual temperature control branches. As a result, different temperatures can occur in the battery system for the individual battery elements. This can lead to different rates of aging of the individual battery elements in the battery system, which in turn can reduce the service life of the entire battery system.

### SUMMARY OF THE DISCLOSURE

It is therefore the object of the present invention to remedy at least in part the disadvantages described above. In particular, it is the object of the present invention to provide, in a cost-effective and simple manner, a temperature control device and a battery system by means of which a temperature control of the battery system as a whole can be improved, it being possible to provide, in particular for individual temperature control branches of the temperature control line of the temperature control device, at least substantially similar temperature control fluid properties such as, for example, temperature, pressure and/or volume flow.

The above object is solved by a temperature control device with the features of independent claim 1 and by a battery system with the features of independent claim 10. Further features and details of the invention result from the dependent claims, the description and the drawings. Features and details which are described in connection with the temperature control device according to the invention naturally also apply in connection with the battery system according to the invention and vice versa in each case, so that with regard to the disclosure of the individual aspects of the invention, mutual reference is or can always be made.

According to a first aspect of the invention, the object is solved by a temperature control device for temperature control of a battery system having at least one battery element, the temperature control device comprising a temperature control line for conducting a temperature control fluid in a flow direction, the temperature control line comprising a flow section, a return section, a first temperature control branch and a second temperature control branch, the first temperature control branch comprising a first inflow opening fluid-communicating connected to the flow section, and a first outflow opening fluid-communicating connected to said return section, said second temperature control branch comprising a first inflow opening fluid-communicating connected to said flow section and a second outflow opening fluid-communicating connected to said return section, wherein further said first temperature control branch and said second temperature control branch are fluid-mechanically connected in parallel to each other and each comprises a temperature control section for temperature control a battery element of said battery system. A temperature control device according to the invention is characterized in that the second inflow opening of the second temperature control branch is arranged downstream of the first inflow opening of the first temperature control branch with respect to the flow direction at the flow section and that the second outflow opening of the second temperature control branch is arranged downstream of the first outflow opening of the first temperature control branch with respect to the flow direction at the return section.

A temperature control device according to the invention can provide temperature control of a battery system or the battery elements of the battery system. For this purpose, the temperature control device has a temperature control line which is configured to conduct a temperature control fluid in one flow direction. The temperature control fluid can be present as a gas, a liquid and/or in a mixed state. The temperature control line branches into at least two temperature control branches, whereby the branching or merging of the temperature control branches takes place at a preliminary section of the temperature control line or a return section of the temperature control line. The individual temperature control branches each have an inlet opening which is connected to the flow section in a fluid-communicating manner. The merging of the temperature control branches to the temperature control line takes place in the return section, whereby the temperature control branches each have an outflow opening, which in turn is connected to the return section in a fluid-communicating manner. In this way it can be provided that the first temperature control branch and the second temperature control branch are connected in fluid mechanical parallel to each other. Already in this way it can be provided that a temperature of the temperature control fluid is similar or preferably at least essentially the same for all temperature control branches that have flowed through, since they all branch off from the same flow section.

Essentially, the invention now provides that with respect to the direction of flow of the temperature control fluid, the inflow openings of the individual temperature control branches at the flow section are arranged in the same order as the outflow openings of the individual temperature control branches at the return section. This is achieved in that the second inflow opening of the second temperature control branch is arranged downstream of the first inflow opening of the first temperature control branch with respect to the flow direction at the flow section and at the same time the second outflow opening of the second temperature control branch is arranged likewise downstream of the first outflow opening of the first temperature control branch with respect to the flow direction at the return section. In other words, the temperature control branch that first branches off from the preliminary section also flows back into the return section as the first. At the same time, the temperature control branch which branches off from the flow section next in the direction of flow of the temperature control fluid also flows into the return section next. In this way it can be provided that the lengths of the flow paths of the at least two temperature control branches are at least similar overall, i.e. in other words that temperature control fluid flowing through the first temperature control branch travels only a short flow path in the flow section and a longer flow path in the return section instead, temperature control fluid flowing through the second temperature control branch travels a longer flow path in the flow section and a shorter flow path in the return section instead. As already described above, the lengths of the flow paths for the temperature control fluid through the individual temperature control branches can thus be adjusted. In addition to the at least essentially similar temperatures of the temperature control fluid in the individual temperature control branches described above, a pressure and/or a volume flow of temperature control fluid in the individual temperature control branches can also be adjusted in this way. A temperature control device according to the invention is thus configured in such a way that it can provide at least essentially the same temperature control performance for all temperature control branches. An equal or at least similar temperature control performance of the temperature control device for all temperature control branches and thus preferably an equal or at least similar temperature load of the battery elements of the battery system tempered by the temperature control device can thereby be provided. Temperature-induced aging processes of these battery elements will therefore usually be the same or at least essentially the same. Since the service life of a battery system is often limited by the most frequently used battery element, in particular by a temperature load, and thus the first battery element to fail, the service life of the battery system can be extended in this way.

Further, in a temperature control device according to the invention, the temperature control line may be provided with at least a third temperature control branch having a third inflow opening fluid-communicating connected to the flow section and a third outflow opening fluid-communicating connected to the return section, the third inflow opening of the third temperature control branch being arranged downstream of the first inflow opening of the first temperature control branch and upstream of the second inflow opening of the second temperature control branch with respect to the flow direction, and in that the third outflow opening of the third temperature control branch is arranged downstream of the first outflow opening of the first temperature control branch and upstream of the second outflow opening of the second temperature control branch with respect to the flow direction, at the return section. Due to the presence of a third temperature control branch, another battery element of the battery system in particular can also be tempered by a temperature control device in accordance with the invention. A temperature control of more complex battery systems and in particular battery systems with several battery elements can thus be provided. The third temperature control branch in turn has an inflow opening and an outflow opening, via which the third temperature control branch is connected to the flow section and the return section. The third temperature control branch is also arranged in the entire temperature control line in such a way that, as a whole, the inflow openings of all the temperature control branches have the same sequence as the outflow openings of all the temperature control branches at the return flow section with respect to the flow direction of the temperature control fluid at the flow section, even in this embodiment of a temperature control device according to the invention. This can be achieved in that the inflow opening of the third temperature control branch is located downstream of the inflow opening of the first temperature control branch at the flow section and upstream of that of the second temperature control branch at the flow section. The same applies to the outflow opening of the third temperature control branch, which is located downstream of the outflow opening of the first temperature control branch at the return section and upstream of the outflow opening of the second temperature control branch at the return section. All the advantages described with regard to the arrangement of the first and second temperature control branches can thus also be provided with three temperature control branches, in particular for a larger number of battery elements to be tempered.

Of course, a temperature control device according to the invention can also have several third temperature control branches, whereby the number of temperature-controlled battery elements of the battery system can be further increased. Analogous to the arrangement of the first three temperature control branches, the inflow opening and the outflow opening of each further arranged temperature control branch also satisfy the condition that the order of the inflow openings and the outflow openings of all the temperature control branches at the flow section and at the return section, respectively, is the same. In all temperature control branches, temperature control fluid with at least essentially the same temperature, pressure and volume flow can be provided. A temperature control performance of an invented temperature control device in all temperature control branches can thus also be provided in all temperature control branches in the same way or at least essentially in the same way.

In addition, a temperature control device according to the invention may provide that, for two temperature control branches of the temperature control line, a flow distance of their inflow openings at the flow section and a return distance of their outflow openings at the return section are of equal length or at least substantially equal length. In this way it can be provided that for these two temperature control branches similar and/or even identical flow paths for temperature control fluid can be provided in these temperature control branches. This is due to the fact that a length of the flow paths of the individual temperature control branches, with the same flow length for the temperature control fluid in the actual temperature control branch, only differs in the length of the flow distance or the return flow distance. This is due in particular to the fact that only in the first temperature control branch the temperature control fluid flows through the return distance, and only in the second temperature control branch the temperature control fluid flows through the flow distance. The fact that the flow distance and the return distance are of equal length or at least essentially equal length makes it particularly easy to provide similar and/or identical flow paths. The two temperature control branches, which have the same flow distance and return distance and are arranged adjacent to each other on the flow section and on the return section, are particularly preferred. In addition, non-adjacent temperature control branches, i.e. temperature control branches separated by at least one other temperature control branch, may have the same lengths for the flow section and the return section, respectively. Similar and/or even identical flow paths can also be provided for temperature control branch pairs that are further apart. In the case of a temperature control device according to the invention, it may be particularly preferred for all temperature control branch pairings that the flow distance and the return distance have the same length or at least essentially the same length. In this way, an equally long or at least essentially equally long flow path can be provided for all possible flow paths through all temperature control branches. An equality of the temperature control capacities that can be provided through all temperature control branches can thus be further increased.

A temperature control device in accordance with the invention may also preferably be configured in such a way that the flow section has a flow start and the return section has a return, wherein the flow start is arranged with respect to the flow direction before the first fluid-communicating connection of the flow section to one of the temperature control branches and the return is arranged with respect to the flow direction after the last fluid-communicating connection of the return section to one of the temperature control branches, further wherein a flow path between the flow start and the return is the same length or at least substantially the same length for all temperature control branches. Such a flow path of equal length or at least substantially equal length enable that in particular to provide that a pressure and/or a volume flow of flowing temperature control fluid through the individual temperature control branches is equal or at least substantially equal. In this way, the same or at least essentially the same temperature control performance can be provided for all temperature control branches. The flow start is defined in the temperature control line in such a way that no branch of a temperature control branch branches off in the flow direction before the flow start. Similarly, the return flow is defined in the temperature control line or the return flow section in such a way that after the return flow there is no further opening of a temperature control branch. Temperature control fluid, which flows from the start of the flow to the return, inevitably flows through one of the temperature control branches. Irrespective of the length of the individual temperature control branches or the individual flow sections or return sections, a global equality of all flow paths makes it particularly easy to ensure that the pressure and/or volume flow of the temperature control fluid is the same or at least essentially the same for all temperature control branches. In the case of temperature control sections of the temperature control branches which are of equal or at least substantially equal length, equality of all flow paths can be provided in particular in that for all temperature control branch pairings a flow distance and a return distance are of equal or at least substantially equal length.

Furthermore, in the case of a temperature control device according to the invention, it may be provided that the temperature control line has at least one throttle device for regulating a pressure and/or a volume flow of the flowing temperature control fluid, the at least one throttle device being arranged in the flow section and/or in a temperature control branch upstream of the temperature control section and/or in a temperature control branch downstream of the temperature control section and/or in the return section. A throttling device may be particularly preferred at several, in particular all, of these positions. In particular, a throttling device of this type can provide an additional adjustment of the pressure and/or volume flow of the temperature control fluid. An even better control, regulation and/or monitoring of the flowing temperature control fluid can thus be provided. An even greater compliance of a temperature load of the battery elements in the entire battery system can be provided in this way.

A temperature control device according to the invention may also be configured such that the flow section has at least two flow branches for fluid-communicating connection with the inflow openings of the temperature control branches and/or the return section has at least two return branches for fluid-communicating connection with the outflow openings of the temperature control branches. In other words, a cascading temperature control system can be provided in this way. The preliminary branches branch off from the preliminary segment and the individual temperature control branches branch off from these. The temperature control branches lead into the return branches, which in turn lead into the return section. In order to retain the advantages according to the invention, the flow branches and the return branches are also arranged on the flow section and the return section, respectively, in such a way that the order of branching off from the flow section is the same order in the direction of flow as the discharge of the return branches into the return section. In other words, with two flow branches and two return branches, the branching of the second flow branch from the flow section will be subordinate to the branching of the first flow branch, and the opening of the second return branch into the return section will also be subordinate to the opening of the first return branch into the return section. In this way, an even larger battery system with even more battery elements can be tempered by a temperature control device according to the invention.

Furthermore, in a temperature control device according to the invention, it may be provided that the inflow openings of the temperature control branches are fluid-communicating connected to a common branch opening of the flow section and/or the outflow openings of the temperature control branches are fluid-communicating connected to a common merge opening of the flow section. In other words, a star branching of the temperature control branches can be provided from the preliminary section or a star merging of the temperature control branches at the return section. Same or at least essentially the same flow paths can be ensured in this embodiment, for example, over a corresponding length of the individual temperature control branches.

In the case of a temperature control device according to the invention, it may also be further provided that the temperature control device comprises a pumping device for generating a flow of the temperature control fluid in the temperature control line in the flow direction. Such a pumping device can in particular ensure that the flow of the temperature control fluid in the flow direction is particularly well controllable and adjustable. Such a pumping device can also be used, for example, in such a way that a pressure and/or a volume flow of the temperature control fluid can be changed. An even better temperature control of the battery elements of the battery system can be provided in this way.

In addition, in a temperature control device according to the invention, it may also be provided that the temperature control device has a heat exchanger for removing heat energy from the temperature control fluid, the heat exchanger being arranged in the temperature control line so as to communicate fluid in the flow direction after the return section. The temperature control functionality of the temperature control device, in particular the cooling of the battery elements by the temperature control device, can be provided particularly easily by such a heat exchanger, which is preferably configured, for example, to release the heat energy from the temperature control fluid to an environment of the temperature control device. Heat energy can also be introduced into the temperature control fluid through the heat exchanger. In this case, the heat exchanger improves the transfer of heat energy to the battery elements, in other words the heating of the battery elements, as part of the object of the invention temperature control device. The heat exchanger is preferably arranged fluid-communicating in the temperature control line after the return section, whereby it is flowed through by the temperature control fluid, which has absorbed heat energy from the battery elements or emitted it to them. In the heat exchanger, this heat energy is taken from the temperature control fluid and preferably released into the environment, for example. Alternatively or additionally, heat energy can also be introduced into the temperature control fluid, which is also preferably taken from the environment, for example through the heat exchanger. In other words, the temperature control fluid has a lower or higher temperature again after the heat exchanger and can, preferably in a closed-circuit system, flow through the temperature control line again and be returned to the temperature control branches.

According to a second aspect of the invention, the object is solved by a battery system comprising at least one battery element and a temperature control device. A battery system according to the invention is characterized in that the temperature control device is configured according to the first aspect of the invention. All the advantages which have been described in detail in relation to a temperature control device in accordance with the first aspect of the invention can thus also be provided by a battery system in accordance with the second aspect of the invention which has such a temperature control device in accordance with the first aspect of the invention.

A battery system according to the invention may be characterized in that the battery system comprises at least two battery elements, each of the at least two battery elements being associated with at least one temperature control branch of the temperature control device. In this way, it can be provided that each of the battery elements can be tempered by its own temperature control branch of the temperature control device. In other words, none of the battery elements of the battery system remains untempered. Alternatively or additionally, several temperature control branches of the temperature control device may be provided for each of the battery elements of the battery system. An even better temperature control of the respective battery elements can thus be provided.

A battery system in accordance with the invention may be developed to the extent that the temperature control branches assigned to the battery elements are connected in parallel by fluid mechanics and that the at least two battery elements are electrically connected in series. In this way it is possible to decouple the electrical wiring of the individual battery elements and the temperature control of the individual battery elements by the temperature control device. The battery elements may be particularly preferred, for example, as battery levels, i.e. as a combination of several battery cells arranged in one level. In this way, an entire battery stack consisting of several electrically serially connected battery levels can be tempered in a particularly preferred way.

A battery system according to the invention may also be configured in such a way that at least one battery element is configured as one of the following elements:
battery cell
group of battery cells
battery level
group of battery levels
battery stacks

This list is not exhaustive, so that, as far as reasonable and possible, at least one battery element can also be configured as additional elements.

### BRIEF DESCRIPTION OF THE FIGURES

Further advantages, features and details of the invention result from the following description, in which embodiments of the invention are described in detail with reference to the drawings. The features mentioned in the claims and in the description may be essential to the invention either individually or in any combination. The explanation of the embodiments describes the present invention exclusively in the context of examples. Of course, individual features of the embodiments can be freely combined with each other, if technically reasonable, without leaving the scope of the present invention. Elements with the same function and mode of action have the same reference signs in the figures. They show schematically:

FIG. 1 a first embodiment of a battery system according to the invention with a temperature control device according to the invention,

FIG. 2 a second embodiment of an invented battery system with an invented temperature control device,

FIG. 3 a third embodiment of a battery system according to the invention with a temperature control device according to the invention, and

FIG. 4 a fourth embodiment of an invented battery system with an invented temperature control device.

### DETAILED DESCRIPTION

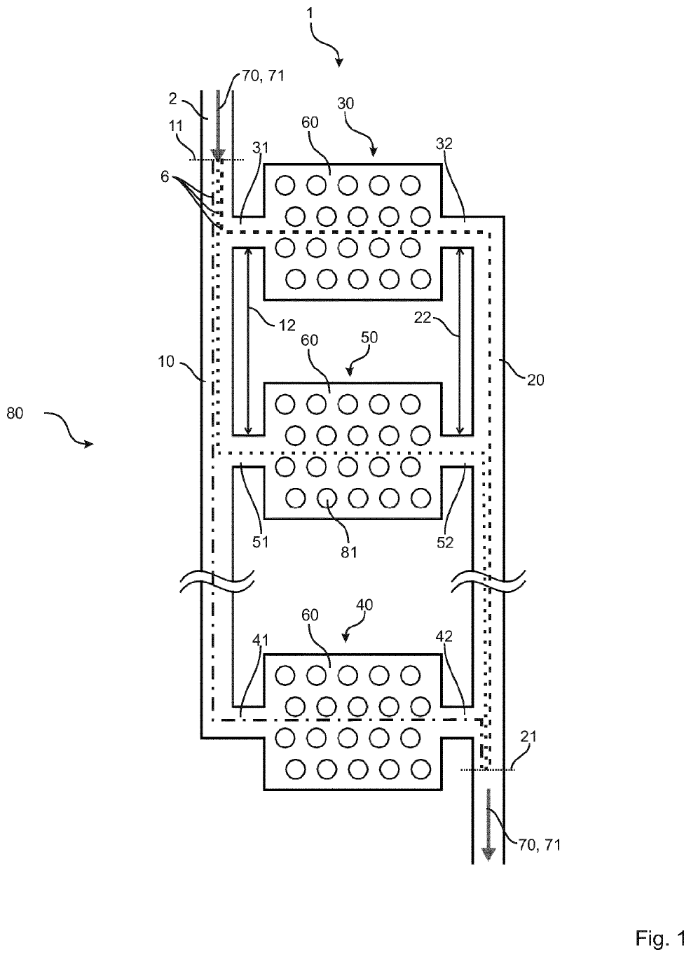

FIG. 1 shows a battery system 80 according to the invention, which is equipped with a temperature control device 1 according to the invention. The battery elements 81 of the battery system 80, only one of which is provided with a reference symbol to increase clarity, are battery cells which are grouped together as groups of individual battery cells. From the invention temperature control device 1 an area is shown which is configured for temperature control of three of these battery elements 81. The temperature control fluid 70 is fed through a temperature control line 2 in a flow direction of 71. In particular, the temperature control line 2 has a flow section 10, a return section 20 and temperature control branches 30, 40, 50 extending between them. The first temperature control branch 30 is fluid-communicating connected to the flow section 10 via a first inflow opening 31, the first outlet opening 32 of the first temperature control branch 30 is fluid-communicating connected to the return section 20. The first temperature control branch 30 further comprises a temperature control section 60 adapted to temper the corresponding battery element 81. Similarly, the second temperature control branch 40 and the third temperature control branch 50 each have an inflow opening 41, 51 and an outflow opening 42, 52 for fluid-communicating connecting the second temperature control branch 40 and the third temperature control branch 50 to the flow section 10 and the return section 20. Essentially invention, the individual inlet openings, 31, 41, 51, with respect to the flow direction 71 of the temperature control fluid 70 are fluid-communicating connected to the flow section 10 in such a way that their order corresponds to the order in which the outlet openings 32, 42, 52 are also fluid-communicating connected to the return section 20. In other words, the second outflow opening 41 of the second temperature control branch 40 is arranged downstream of the third outflow opening 51 of the third temperature control branch 50 at the flow section 10, this in turn being arranged downstream of the first outflow opening 31 of the first temperature control branch 30. Correspondingly, the second outflow opening 42 of the second temperature control branch 40 is arranged downstream of the third outflow opening 52 of the third temperature control branch 50 and this in turn is arranged downstream of the first outflow opening 32 of the first temperature control branch 30. In this way it can already be provided that flow paths 6, which preferably extend between a flow start 11 in the flow section 10 and a return section 21 in the return section 20, are the same length or at least substantially the same length for all temperature control branches 30, 40, 50. By a flow distance 12, which extends through the distance along the flow direction 71 between, here exemplarily illustrated, the first inlet opening 31 of the first temperature control branch 30 and the third inlet opening 51 of the third temperature control branch 50, which is equal to or at least substantially equal to a return distance 22 between the corresponding outlet openings 32, 52, these flow paths of equal length or at least substantially equal length 6 can be provided particularly easily. Altogether it can be provided by a temperature control device 1 in accordance with the invention and in particular by the special arrangement and fluid-communicating connection of the temperature control branches 30, 40, 50 with the flow section 10 and the return section 20, respectively, that the temperature control fluid 70 for all the temperature control branches 30, 40, 50 and their temperature control sections 60 on the one hand has a similar or preferably the same temperature and on the other hand also has a similar pressure and/or a similar volume flow of temperature control fluid 70. A temperature control performance which is similar or preferably even the same for all temperature control branches 30, 40, 50 can thus be provided. Different temperature loads of the individual battery elements 81 of the battery system 80 can thus be avoided. This prevents the individual battery elements from aging at different rates and thus shortens the service life of a battery system 80 according to the invention.

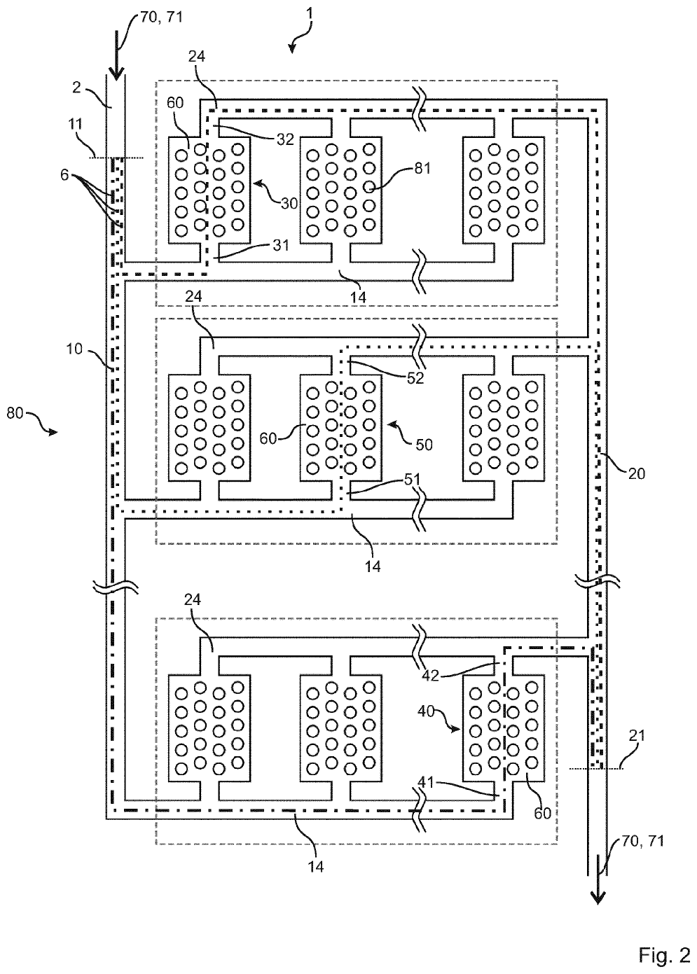

FIG. 2 shows a further embodiment of a battery system 80 according to the invention with a temperature control device 1 according to the invention. Compared to FIG. 1, this battery system 80 has considerably more battery elements 81. Of the battery elements 81, only a single battery element 81 is provided with a reference symbol to improve the overview. The battery elements 81 are in turn battery cells, which are grouped together, whereby the groups of battery cells are in turn arranged in one battery level. In the configuration shown, the battery system 80 has three such battery levels, which can preferably be electrically connected in series. In addition to the elements already described in FIG. 1, the temperature control device 1 according to the invention in this configuration has a flow branch 14 and a return branch 24 for each of the battery levels. The flow branches 14 branch off from flow section 10 and are fluid-communicating connected to it. Analogously, the return branches 24 lead into the return section 20 and are also fluid-communicating connected to this section. The individual temperature control branches 30, 40, 50 of the temperature control device according to invention 1 extend between each of the flow branches 14 and the return branches 24. The order of the connections of the individual temperature control branches 30, 40, 50 with the respective flow branch 14 or return branch 24 corresponds to the order described in FIG. 1 with respect to the flow section 10 and the return section 20 with all properties and advantages described therein. In this way the same advantages and characteristics in terms of temperature, pressure and/or volume flow of the temperature control fluid 70 can be provided for each of the sections consisting of flow branch 14, return branch 24 and temperature control branches 30, 40, 50 arranged between them for each of the temperature control branches 30, 40, 50. Furthermore, the branches of the flow branches 14 with respect to the flow direction 71 of the temperature control fluid 70 are also arranged in the same order on the flow section 10 as the return branches 24 are arranged on the return section 20. The resulting flow paths 6 are shown for three exemplarily selected temperature control branches 30, 40, 50. By means of the above described corresponding arrangement of the order of both the branches of the flow branches 14 and the return branches 24 as well as the inlet openings 31, 41, 51 and the outlet openings 32, 42, 52 of the temperature control branches 30, 40, 50, respectively, it can again be achieved that these flow paths 6 are of equal length or at least substantially equal length. All battery elements 81, which are arranged in battery levels as described here, can thus be provided with the same or at least essentially the same temperature control performance of the temperature control device 1 in accordance with the invention.

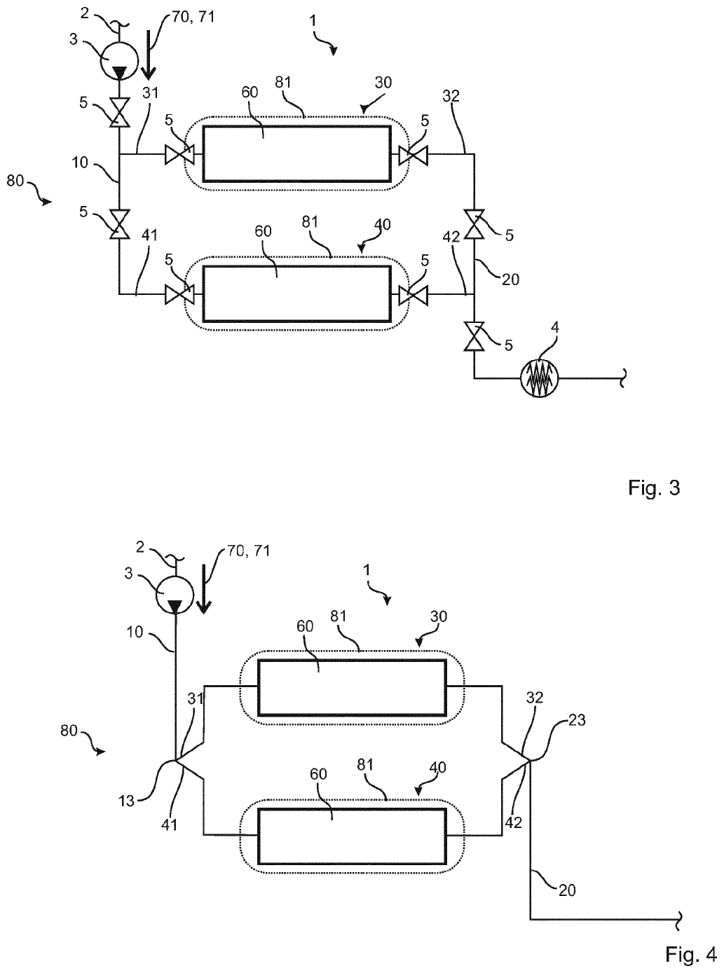

FIG. 3 schematically shows a further embodiment of a battery system 80 according to the invention which is equipped with a temperature control device 1 according to the invention. In addition to the order of the arrangement of the first temperature control branch 30 and the second temperature control branch 40 and their inflow openings 31, 41 and outflow openings 32, 42 at the flow section 10 and return section 20 of the temperature control line 2, respectively, which is essential for the invention and has already been described, in particular throttle elements 5 are shown in this configuration. These throttle elements 5 can, for example, be arranged in preliminary section 10 in the individual temperature control branches 30, 40 before and after temperature control section 60, but also alternatively or additionally in return section 20. Such throttling devices 5 can be used to additionally regulate, set and/or control the pressure and/or volume flow of the temperature control fluid 70. An even more precise setting of a temperature control capacity in the individual temperature control branches 30, 40, which can be provided by the temperature control section 60 for the individual battery elements 81 of the battery system 80, can thus be made possible. Furthermore, a pumping device 3 is shown in this configuration, which is configured to provide the flow of the temperature control fluid 70 in the flow direction 71. This pumping device 3 can also influence, in particular regulate and control, the pressure and/or volume flow of the temperature control fluid 70. Furthermore, a heat exchanger 4 is shown, which is arranged in the temperature control line 2 after the return section 20. With such a heat exchanger, the heat energy absorbed in temperature control sections 60 in particular can be at least partially removed from the temperature control fluid 70 and, for example, released into the environment. In particular, a circulation system with a closed temperature control line 2 can thus be provided particularly easily with a temperature control device 1 according to the invention.

FIG. 4 shows a further embodiment of a battery system 80 according to the invention with a temperature control device 1 according to the invention. In addition to the elements already described in relation to the other figures, such as a pump device 3, a first 30 and a second temperature control branch 40 and their arrangement according to the invention. It is shown in FIG. 4 that a branch opening 13 can be provided in the flow section 10, which is fluid-communicating connected both to the first inflow opening 31 of the first temperature control branch 30 and to the second inflow opening 41 of the second temperature control branch 40. Similarly, the return section 20 may have a merge opening 23 which may be fluid communicating connected to the first outflow opening 32 of the first temperature control branch 30 and the second outflow opening 42 of the second temperature control branch 40. In this way, a particularly simple and in particular short flow section 10 or return section 20 can be provided. Ensuring, for example, an identical flow path 6 (not shown) through all temperature control branches 30, 40 can be ensured in this embodiment, in particular by the individual length of the respective temperature control branch 30, 40.

1. A temperature control device for temperature control of a battery system having at least one battery element, the temperature control device having a temperature control line for conducting a temperature control fluid in a flow direction, the temperature control line having a flow section, a return section, a first temperature control branch and a second temperature control branch, the first temperature control branch comprising a first inflow opening fluid-communicating connected to the flow section and a first outflow opening fluid-communicating connected to the return section, the second temperature control branch comprising a second inflow opening fluid-communicating connected to the flow section, and a second outflow opening which is fluid-communicating connected to the return section, the first temperature control branch and the second temperature control branch further being connected in fluid-mechanical parallel to one another and each having a temperature control section for temperature control a battery element of the battery system, wherein the second inflow opening of the second temperature control branch is arranged downstream of the first inflow opening of the first temperature control branch with respect to the flow direction on the flow section, and in that the second outflow opening of the second temperature control branch is arranged downstream of the first outflow opening of the first temperature control branch with respect to the flow direction on the return section.

2. The temperature control device according to claim 1, wherein the temperature control line has at least one third temperature control branch with a third inflow opening, which is fluid-communicating connected to the flow section, and a third outflow opening, which is fluid-communicating connected to the return section, wherein the third inflow opening of the third temperature control branch is arranged downstream of the first inflow opening of the first temperature control branch and upstream of the second inflow opening of the second temperature control branch with respect to the flow direction at the flow section, and in that the third outflow opening of the third temperature control branch is arranged downstream of the first outflow opening of the first temperature control branch and upstream of the second outflow opening of the second temperature control branch with respect to the flow direction on the return section.

3. The temperature control device according to claim 1, wherein, for two temperature control branches of the temperature control line, a flow distance of its inflow openings on the flow section and a return distance of its outflow openings on the return section is of equal length or at least substantially equal length.

4. The temperature control device according to claim 1, wherein the flow section has a flow start and the return section has a return flow, the flow start with respect to the direction of flow prior to the first fluid-communicating connection of the flow section to one of the temperature control branches and the return flow is arranged with respect to the flow direction after the last fluid-communicating connection of the return flow section to one of the temperature control branches, wherein furthermore a flow path between the flow start and the return flow is the same length or at least substantially the same length for all temperature control branches.

5. The temperature control device according to claim 1, wherein the temperature control line has at least one throttle device for regulating at least a pressure or a volume flow of the flowing temperature control fluid, the at least one throttle device being arranged in at least the flow section or in a temperature control branch upstream of at least the temperature control section or in a temperature control branch downstream of the temperature control section or in the return section.

6. The temperature control device according to claim 1, wherein the flow section has at least two flow branches for fluid-communicating connection to the inflow openings of at least the temperature control branches or the return section has at least two return branches for fluid-communicating connection to the outflow openings of the temperature control branches.

7. The temperature control device according to claim 1, wherein the inflow openings of the temperature control branches are connected in fluid-communicating manner to at least a common branch opening of the flow section or the outflow openings of the temperature control branches are connected in fluid-communicating manner to a common merge opening of the flow section.

8. The temperature control device according to claim 1, wherein the temperature control device has a pumping device for generating a flow of the temperature control fluid in the temperature control line in the flow direction.

9. The temperature control device according to claim 1, wherein the temperature control device has a heat exchanger for removing heat energy from the temperature control fluid, the heat exchanger being arranged in the temperature control line so as to communicate fluid in the flow direction after the return section.

10. A battery system having at least one battery element and a temperature control device, wherein the temperature control device is configured for temperature control of a battery system having at least one battery element, the temperature control device having a temperature control line for conducting a temperature control fluid in a flow direction, the temperature control line having a flow section, a return section, a first temperature control branch and a second temperature control branch, the first temperature control branch comprising a first inflow opening fluid-communicating connected to the flow section and a first outflow opening fluid-communicating connected to the return section, the second temperature control branch comprising a second inflow opening fluid-communicating connected to the flow section, and a second outflow opening which is fluid-communicating connected to the return section, the first temperature control branch and the second temperature control branch being connected in fluid-mechanical parallel to one another and each having a temperature control section for temperature control a battery element of the battery system, wherein the second inflow opening of the second temperature control branch is arranged downstream of the first inflow opening of the first temperature control branch with respect to the flow direction on the flow section, and the second outflow opening of the second temperature control branch is arranged downstream of the first outflow opening of the first temperature control branch with respect to the flow direction on the return section.

11. The battery system according to claim 10, wherein the battery system has at least two battery elements, at least one temperature control branch of the temperature control device being assigned to each of the at least two battery elements.

12. The battery system according to claim 11, wherein the temperature control branches assigned in each case to the battery elements are connected in fluid mechanical parallel, and in that the at least two battery elements are electrically connected in series.

13. The battery system according to claim 10, wherein the at least one battery element is formed as at least one element selected from the group consisting of: a battery cell, a group of battery cells, a battery level, a group of battery levels, and battery stacks.
